(19) United States
(12) Patent Application Publication
(10) Pub. No.: US 2023/0229124 A1
(43) Pub. Date: Jul. 20, 2023

(54) OPERATION CONTROL SYSTEM AND A CONTROL METHOD FOR A GAS-STEAM COMBINED CYCLE GENERATOR UNIT

(71) Applicant: ZHEJIANG UNIVERSITY CITY COLLEGE, Hangzhou (CN)

(72) Inventors: Anping WAN, Hangzhou (CN); Jie YANG, Hangzhou (CN); Jiabo HE, Hangzhou (CN); Jiantao YUAN, Hangzhou (CN); Zhihua GAN, Hangzhou (CN); Bo WANG, Hangzhou (CN); Ting CHEN, Hangzhou (US); Guanqun LUO, Hangzhou (CN)

(73) Assignee: ZHEJIANG UNIVERSITY CITY COLLEGE, Hangzhou (CN)

(21) Appl. No.: 17/791,224

(22) PCT Filed: Jan. 25, 2022
(86) PCT No.: PCT/CN2022/073741

§ 371 Date: Jul. 7, 2022

(30) Foreign Application Priority Data
Aug. 27, 2021 (CN) 202110997442.8

(51) Int. Cl. G05B 19/042

(52) U.S. Cl. CPC G05B 19/042; G05B 2219/2639

(57) ABSTRACT

An operation control system for a gas-steam combined cycle generator unit-includes a real-time operation data acquisition module, to collect the operation parameter data and power generation data of a power plant unit, an operation status evaluation index mining module, to mine and analyze the operation parameter data of a power plant unit to get key parameters, an operation status evaluation index extraction module, to obtain characteristic variables, an operation characteristic parameter prediction module, to predict the said characteristic variables and obtain the predicted value and the corresponding change trend, and an operation intelligent control module, to realize the intelligent control of parameters. The operation control system can guide the optimal operation of power plant units, and improve their operation reliability and economy.

### TECHNICAL FIELD

The present invention relates to the technical field of intelligent power regulation, and particularly to an operation control system and a control method for a gas-steam combined cycle generator unit.

### BACKGROUND

At present, gas-steam combined cycle power generation has become one of the main development directions of thermal power generation around the world, due to its high overall cycle thermal efficiency, mild environmental pollution, low unit investment under the same conditions, good peak shaving performance, fast start-up and shutdown, small land occupation, less water consumption, short construction cycle, phased commissioning, high degree of automation and few operators.

However, there are two major deficiencies in the current research about generating unit operation parameter control:

(1) The actual operation status of the unit is not fully considered in the operation parameter control. The theoretical model established according to the operation parameters of the power plant unit fails to take a full account of the practical operation of power production in the calculation, and the theoretical research simplifies many factors, so the optimal value obtained from the theoretical calculation cannot be used as the practical control value. During unit operation parameter design, the practical reality of power production shall be considered, such as unit operation status, equipment health status and other unpredictable factors. The consideration of these factors requires the participation of experienced unit operators. The setting values of the final operation parameters should not be determined only by computers, and instead they need the judgment and adjustment of experienced operators. Therefore, the optimal setting of operation parameters of power plant units represents a combination of intelligence and manual work.

(2) Research based on power plant sample data shows limitations.

First, in the collection and acquisition of power plant data, researchers are limited by the informatization level of power companies and cannot obtain massive historical operation data of power plant units. Secondly, in the era of small data, even if a large amount of data is obtained from power plants, it is impossible to have distributed processing of the data due to the lack of big data analysis platform. The researchers, based on sample data, only a small part of the overall data, cannot accurately and comprehensively reflect the characteristics and laws of the overall data. Therefore, estimation of the overall picture using the research results based on sample data may have great errors, and is less satisfactory in the practical application of power production.

As a result, how to provide an operation control system and control method for gas-steam combined cycle generator units that can tackle the above deficiencies is an urgent issue for those skilled in the art.

### SUMMARY

In view of the above, the present invention provides an operation control system and a control method for a gas-steam combined cycle generator unit to solve the problems of high time and labor cost, and low efficiency and accuracy of manual control of operation parameters during the operation and management of power plant units.

To achieve the above purpose, the present invention is implemented with the following technical scheme:

An operation control system for a gas-steam combined cycle generator unit, which comprises

A real-time operation data acquisition module, to collect the operation parameter data and power generation data of a power plant unit,

An operation status evaluation index mining module, to mine and analyze the operation parameter data of a power plant unit to get key parameters,

An operation status evaluation index extraction module, to obtain characteristic variables,

An operation characteristic parameter prediction module, to predict the said characteristic variables and obtain the predicted value and the corresponding change trend,

And an operation intelligent control module, to realize the intelligent control of parameters.

Preferably, it further comprises an operation status evaluation index selection module, to screen the said key parameters, obtain operation parameters that are positively correlated with the said power generation data, and send the said operation parameters to the said operation status evaluation index extraction module for processing.

Preferably, it further comprises an operation status evaluation index analysis module, to analyze the said key parameters and obtain the operating condition stability judgment parameters.

Preferably, it further comprises a steady operating condition establishment module, to label the said operating condition stability judgment parameters, and establish a stable operating condition database.

Preferably, it further comprises a data preprocessing module, to preprocess the said operation parameter data of a power plant unit.

Further, the present invention further provides a method for optimizing and controlling the operation parameters of a power plant unit, which comprises

Step 1: obtain the operation parameter data and power generation data of a power plant unit with the said real-time operation data acquisition module, and preprocess the data;

Step 2: mine the said operation parameter data obtained in Step 1 with the said operation status evaluation index mining module to get the key parameters;

Step 3: process the said key parameters with the said operation status evaluation index extraction module and multiple modules to get corresponding characteristic variables;

Step 4: predict the said characteristic variables with the operation characteristic parameter prediction module to get the predicted value and the corresponding change trend;

Step 5: analyze the said key parameters with the said steady operating condition establishment module to get the said operating condition stability judgment parameters, and label the said operating condition stability judgment parameters to establish a stable operating condition database;

Step 6: in combination with the said stable operating condition database, the said predicted value and the corresponding change trend, carry out comparative control with the said operation intelligent control module, to realize intelligent control.

Preferably, the said Step 3 further comprises Step 31: screen the said key parameters with the said operation status evaluation index selection module to get the operation parameters that are positively correlated with the said power generation data;

Step 32: analyze the said operation parameters with the said operation status evaluation index analysis module to get the operating condition stability judgment parameters.

Preferably, in the said Step 2, an improved association rule mining method is used to mine the operation parameter data.

Preferably, in the said Step 32, a clustering method is used to have a correlation analysis of the said operation parameters to get the operating condition stability judgment parameters.

According to the above technical scheme, compared with the prior art, the present invention discloses and provides an operation control system and a control method for a gas-steam combined cycle generator unit, which integrates and has correlation analysis of the parameters of historical and real-time operation data of power plant units based on big data mining algorithm. The key parameters that affect the operation of power plant units obtained can be are used as indexes of unit health status assessment. The LSTM neural network model is used to train the eigenvalues determined in the health status feature acquisition module of power plant units, to predict the change trend of the parameters over time, and to realize the intelligent control of the units. Finally, a gas-steam combined cycle generator unit operation control system is developed, which can guide the optimal operation of the power plant units and improve their operating reliability and economy.

### BRIEF DESCRIPTION OF THE DRAWINGS

To better describe the embodiment of the present invention or the technical scheme of the prior art, a brief introduction of the accompanying drawings to be used in the descriptions of the embodiment or the prior art is made hereby. Obviously, the drawings below are only the embodiment of the present invention, and for those ordinarily skilled in the art, other drawings based on such drawings can be obtained without making creative endeavors.

FIG. 1 is a structural principle block diagram of an operation control system for a gas-steam combined cycle generator unit provided by the present invention;

FIG. 2 is a specific flowchart of a clustering process provided in Embodiment 1 of the present invention;

FIG. 3 is a specific flowchart of the intelligent control provided by Embodiment 1 of the present invention;

FIG. 4 is a specific flowchart of the improved association rule mining method provided in Embodiment 1 of the present invention.

### DETAILED DESCRIPTION OF THE EMBODIMENTS

The technical schemes in the embodiments of the present invention are clearly and completely described below in combination with the drawings of the embodiments of the present invention. Obviously, such embodiments are just a part of embodiments of the present invention, not all of them. Based on the embodiments of the present invention, all the other embodiments obtained by those ordinarily skilled in the art without making creative endeavors shall fall into the scope of protection of the present invention.

### Embodiment 1

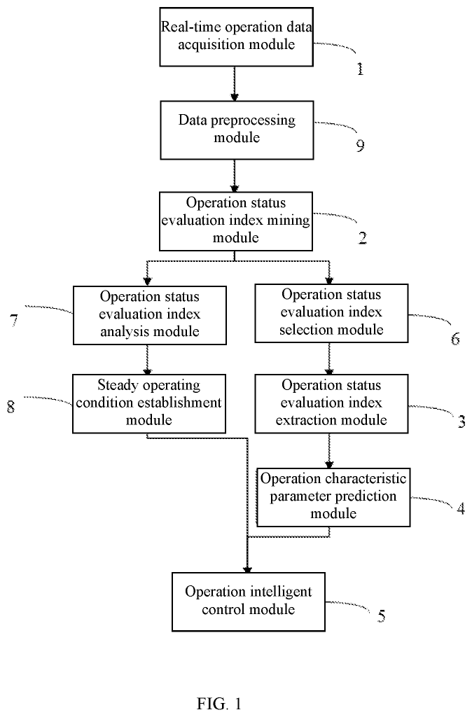

Referring to FIG. 1, Embodiment 1 of the present invention provides an operation control system for a gas-steam combined cycle generator unit, which comprises

A real-time operation data acquisition module 1, to collect the operation parameter data and power generation data of a power plant unit,

An operation status evaluation index mining module 2, to mine and analyze the operation parameter data of a power plant unit to get key parameters,

An operation status evaluation index extraction module 3, to obtain characteristic variables,

An operation characteristic parameter prediction module 4, to predict the said characteristic variables and obtain the predicted value and the corresponding change trend,

Among them, the operation characteristic parameter prediction module 4 trains the characteristic quantities determined in the power plant unit health status characteristic acquisition module with the LSTM neural network model, and predicts the change trend of the parameters over time to assist the status judgment.

And an operation intelligent control module 5, to realize the intelligent control of parameters.

In a specific embodiment, it further comprises an operation status evaluation index selection module 6, to screen the key parameters, obtain operation parameters that are positively correlated with the power generation data, and send the operation parameters to the operation status evaluation index extraction module 3 for processing.

In a specific embodiment, it further comprises an operation status evaluation index analysis module 7, to analyze the said key parameters and obtain the operating condition stability judgment parameters.

In a specific embodiment, it further comprises a steady operating condition establishment module 8, to label the operating condition stability judgment parameters, and establish a stable operating condition database.

In a specific embodiment, it further comprises a data preprocessing module 9, to preprocess the operation parameter data of a power plant unit. The data preprocessing module 9 performs abnormal value processing, missing value processing, discretization processing and normalization processing on the data collected by the power plant unit, preparing for the follow-up data mining and analysis.

Further, Embodiment 1 of the present invention also provides a method for optimizing and controlling the operation parameters of a power plant unit, which comprises

Step 1: obtain the operation parameter data and power generation data of a power plant unit with the real-time operation data acquisition module 1, and preprocess the data;

Step 2: mine the operation parameter data obtained in Step 1 with the operation status evaluation index mining module 2 to get the key parameters;

Step 3: process the key parameters with the operation status evaluation index extraction module 3 and multiple modules to get corresponding characteristic variables;

Step 4: predict the characteristic variables with the operation characteristic parameter prediction module 4 to get the predicted value and the corresponding change trend;

Step 5: analyze the key parameters with the steady operating condition establishment module 8 to get the operating condition stability judgment parameters, and label the operating condition stability judgment parameters to establish a stable operating condition database;

Step 6: in combination with the stable operating condition database, the predicted value and the corresponding change trend, carry out comparative control with the operation intelligent control module 5, to realize intelligent control.

In a specific embodiment, the Step 3 further comprises Step 31: screen the key parameters with the operation status evaluation index selection module 6 to get the operation parameters that are positively correlated with the power generation data;

Step 32: analyze the said operation parameters with the said operation status evaluation index analysis module 7 to get the operating condition stability judgment parameters.

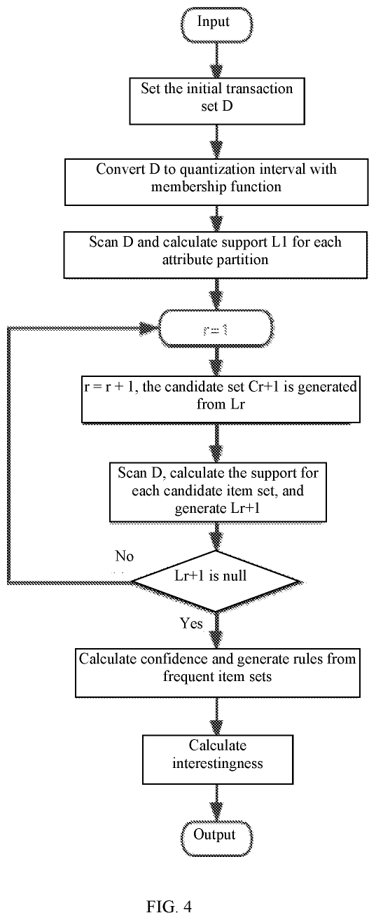

Referring to FIG. 4, in a specific embodiment, in Step 2, the operation parameter data is mined by using the improved association rule mining method, and the specific process is as follows:

In FIG. 4, the input is a transaction database D composed of n transactions. Each transaction contains in sub-items. There is a set of membership functions, and the j^{th} (j=1, 2, 3 . . . , m) item in the i^{th} (i=1, 2, 3 . . . , n) transaction data can be described by the k^{th} membership function μᵢ(Rⱼₛ) (s=1, 2,3 . . . , k). The set minimum support threshold is mins and the minimum confidence threshold is minc. The output is a set of quantitative association rules.

The running process of the improved algorithm is as follows:

1) Represent each item (j=1, 2, . . . m) of each transaction data Tᵢ (i=1, 2, . . . , n) in the transaction database D with a given membership function as a quantization interval, and describe the items as a set of quantization intervals using Zadeh notation, as shown in Formula (1):

$${f}_{i}^{j} = \frac{{μ}_{i} ( {R}_{j 1} )}{{R}_{j 1}} + \frac{{μ}_{i} ( {R}_{j 2} )}{{R}_{j 2}} + … + \frac{{μ}_{i} ( {R}_{jk} )}{{R}_{jk}} \qquad ( 1 )$$

Wherein, fᵢ^{j} and tᵢ^{j} are the corresponding quantization interval sets, Rⱼᵢ is the i^{th} quantization interval partition of item tᵢ^{j}, and μᵢ(Rⱼᵢ) is the membership value on partition Rⱼᵢ.

2) Calculate the weight of the membership degree of each item tᵢ^{j} (j=1, 2 , . . . m) in n transaction data Ti (i=1, 2, . . . , n) in the corresponding quantization interval set Rⱼᵢ (s=1, 2, . . . k). The specific expression is shown in Formula (2):

$${weight}_{js} = \frac{1}{n} {\sum }_{i = 1}^{n} {μ}_{i} ( {R}_{js} ) \qquad ( 2 )$$

Wherein, weightⱼₛ is the weight of membership degree, n is the number of transaction data, and μᵢ(Rⱼₛ) is the membership function.

3) For each partition Rⱼᵢ (1≤j≤m, 1≤s≤k), verify whether the weight of each transaction set is not less than the preset minsupport. If the partition weightⱼₛ meets that, then put it into the frequent item set L1, as shown in Formula (3):

L₁={Rⱼₛ|weightⱼₛ≥min support, 1≤j≤m, 1≤s≤m} (3)

Wherein, minsupport is a preset minimum weight.

4) Set r=1, to calculate the total number of transactions remaining in the items after filtering.

5) Generate a candidate item set Cᵣ₊ᵢ from the frequent item set Lᵣ by Apriori. Lᵣ has r−1 identical items in two item sets, while other items are different and belong to two partitions of the same item and thereby can not appear in the same item of the candidate item set Cᵣ₊ᵢ at the same time.

6) Process each newly generated r+1 item set in the candidate item set Cᵣ₋₁ as follows:

a. For each transaction data Tᵢ, calculate the membership value of the item t in the candidate large item set in the total transaction item set, as shown in Formula (4):

μᵢₜ=μᵢ(Rₜ_{₁})\hat{ }μᵢ(Rₜ_{₂})\hat{ } . . . μᵢ(Rₜᵣ₊₁) (4)

Wherein, μᵢ(Rₜ_{ⱼ}) is the membership value of the transaction data Tᵢ on the partition.

If the minimum operators have intersection, then

μᵢₜ=Min μᵢ(Rₜ_{ⱼ}) (5)

b. Solve the weight in each sub-item.

$${weight}_{t} = \frac{1}{n} {\sum }_{i = 1}^{n} {μ}_{it} \qquad ( 6 )$$

c. If weightₜ is not less than the previously set threshold minsupport, put item t=t₁, t₂. . . , t_{r°1}) into Lᵣ₊₁.

7) If it is null, go to the next step; otherwise set r=r+1 and repeat Steps 5-7.

8) Establish solution rules for all large q (q≥2) item sets t with item 1.

9) According to the formula, add the interestingness as a new measure, and the interestingness function is

$$I ( A ⇒ B ) = \frac{1 - P ( B )}{( 1 - P ( B ) ) * ( 1 - P ( A ⋂ B ) )}$$

The larger the value of the interestingness I, the more valuable this association rule is. The larger the minimum I value is set, the less the mining results will be, and vice versa.

The effective association rules with quantization interval attributes mined by the above quantization interval association rule mining algorithm have high reference value for the setting of the final operation parameters.

In a specific embodiment, the specific screening process of Step 31 is as follows:

Analyze the correlation between key parameters by the correlation analysis method, select the operation parameters that are significantly positively correlated with the power generation data (i.e. the combined cycle power of gas-steam combined cycle generator set), calculate the corresponding Pearson correlation coefficient, and mine the key characteristic parameters that meet the requirements through stability judgment, extreme value standardization, membership degree setting, quantization interval division and minimum support and minimum confidence value adjustment.

In a specific embodiment, in Step 32, a clustering method is used to perform a correlation analysis of the operation parameters to get the operating condition stability judgment parameters. The specific process is as follows:

Determine the stability judgment index of the critical value that may lead to abnormal operation combining the practical production experience, and further screen the preprocessed data within the limited range of multiple critical values to find the data that meets all the restrictive conditions. The screening result is used as input data for clustering.

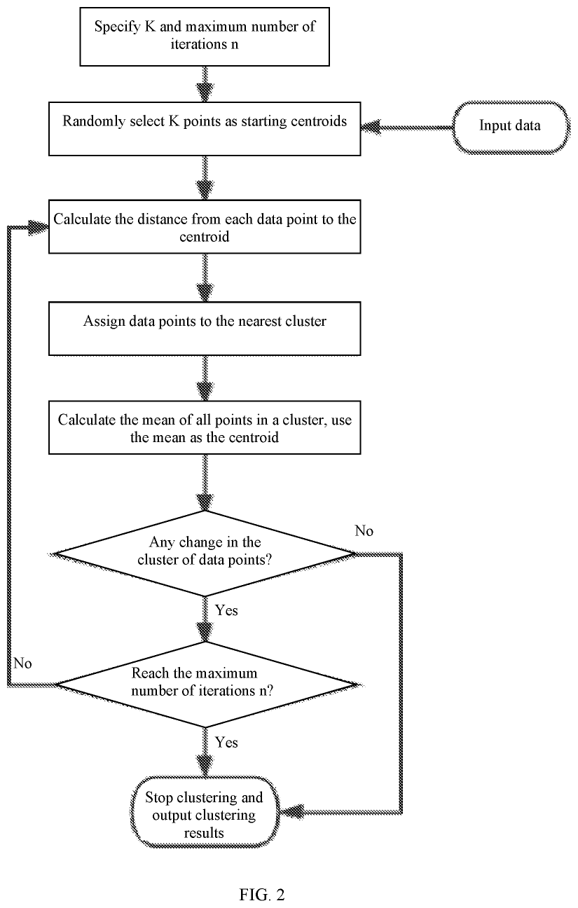

Referring to FIG. 2, a flowchart of the K-means cluster analysis of the health status of the unit, when performing K-nearest neighbor cluster analysis on the data to be clustered after data mining and extraction in the relational database, it is necessary to set the number of clusters K and the maximum number of iterations n, and then randomly select K data points as the starting centroid. By calculating the distance from each data point to the centroid, the data points are assigned to the cluster with the smallest distance value, and the centroid of each cluster is updated repeatedly by the mean value. The clustering is ended until the cluster of data points shows no changes or the maximum number of iterations n is reached, and results are output. In the practical application process, technicians can set several categories according to the determined optimization characteristic parameters of the power plant units, define the characteristics of each category, classify the data after feature mining, and demarcate the stable and unstable status.

In a specific embodiment, in Step 5, the steady operating condition establishment module 8 is used to label the operating condition stability judgment parameters, and to establish the stable operating condition database. The specific process is as follows:

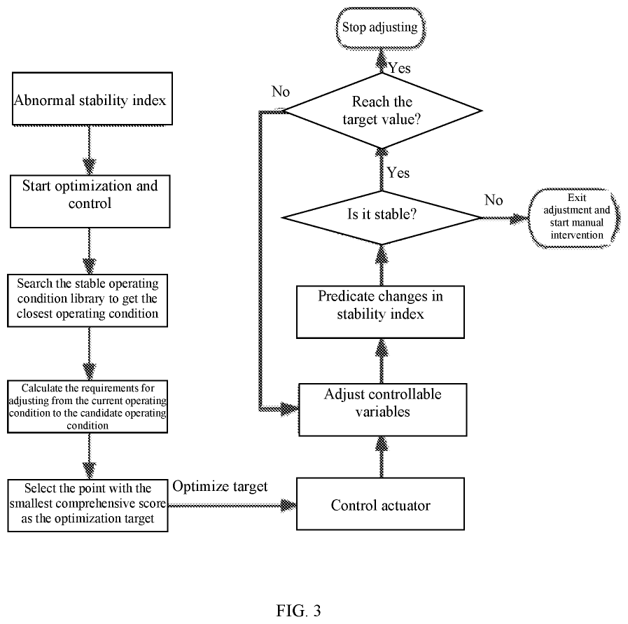

Complete the category labeling of the existing operating condition records of power plant units according to the definition of data status in cluster analysis, set the steady and unsteady category labels as 0 and 1 respectively, extract the stable operating condition, and establish the stable operating condition database. As shown in FIG. 3 (process of establishing the stable operating condition mode library of the unit), an operating condition contains controllable variables x, stability characterization variables y and category labels. For each operating condition, calculate the distance between the parameters in x and the existing operating conditions in the library. If the distance is zero, it is considered that the operating condition already exists in the library and will not be recorded again. Otherwise, add the time tag to the operating condition and store it in the stable operating condition library in the form of vector.

Referring to FIG. 3, the specific process of judging whether the operation of the unit is stable in Step 6 is as follows:

1) In case of any abnormal parameters in the stability index, the program, if started, will search for the control target from the stability mode library, and return the point closest to the current status as the candidate operating condition.

2) Compare the current status and the candidate operating condition, and count the parameters that need to be controlled when the current status is adjusted to the target, the control range and the number of parameters to be controlled. Determine a control target from the candidate operating conditions from the three dimensions. The control target shall be determined in such a way that ensures the minimum number of control parameters and the minimum control range.

3) After determining the target, adjust the controllable variables according to the set adjustment range until the parameters reach the target values. During the control process, the change trend of the stable index will be monitored. If it does not return to normal, the control will be stopped at any time and the manual regulation will be started.

### Embodiment 2

The system and method provided in Embodiment 1 of the present invention are put into operation in a combined cycle power plant, and the historical operation parameters of a generator unit in the plant in a year are selected for analysis and processing. When the interval value of the combined cycle power is high, the optimal value range of flue gas temperature at the inlet of waste heat boiler is [881.2431, 888.4293]K, and the optimal value range of steam temperature at the outlet of reheater is [831.3329, 838.2954]K. The parameter value of operation optimization is selected in the optimal interval. For convenience, the central value of the interval is taken as the optimal value in this embodiment. The obtained optimal value of flue gas temperature at the inlet of waste heat boiler is 884.2362K and the optimal value of steam temperature at the outlet of reheater is 834.8142K.

Following the above steps, the optimal values of the operation parameters of the power plant unit under specific operating conditions are obtained for all the valid association rules of data mining. Table 1 shows the comparison of the target values of some controllable operation parameters determined by the traditional method and the improved association rule method. In the table, 1-10 represent the waste heat boiler outlet flue gas temperature/K, waste heat boiler outlet flue gas pressure/Mpa, reheater outlet steam temperature/K, high pressure cylinder exhaust pressure/Mpa, high pressure cylinder exhaust temperature/K, low pressure cylinder inlet steam temperature/K, low pressure cylinder inlet steam pressure/Kpa and combustion chamber inlet flue gas temperature/K.

TABLE 1
Comparison of original and optimized values of
unit operation parameters

| | Original | | |
|---|---|---|---|
| | setting | Optimized | |
| Parameter | value | value | Increase/% |
| Waste heat boiler outlet flue gas | 345.0850 | 355.3850 | 3.000 |
| temperature/K | | | |
| Waste heat boiler outlet flue gas | 73.8000 | 104.0770 | 41.000 |
| pressure/Mpa | | | |
| Reheater outlet steam | 304.4000 | 434.8142 | 42.800 |
| temperature/K | | | |
| High pressure cylinder exhaust | 1970.3426 | 1985.2138 | 0.755 |
| pressure/Mpa | | | |
| High pressure cylinder exhaust | 615.4865 | 632.2643 | 2.730 |
| temperature/K | | | |
| Low pressure cylinder inlet steam | 398.5642 | 434.7157 | 9.070 |
| temperature/K | | | |
| Low pressure cylinder inlet steam | 2733.5624 | 2788.8509 | 2.020 |
| pressure/Kpa | | | |
| Combustion chamber inlet flue gas | 344.6541 | 357.8299 | 3.715 |
| temperature/K | | | |

As can be seen from Table 1, the original parameters are generally lower than the optimized values based on the optimal parameter setting values obtained by the improved association rule mining method, which indicates that the parameter values are controlled within the safe range during the operation of power plant units to reduce the occurrence of accidents.

Each embodiment in this specification is described in a progressive manner, focusing on its differences from other embodiments, and the same and similar parts between embodiments can be referred to mutually. For the device disclosed in the embodiments, since it corresponds to the method disclosed in the embodiments, the description is relatively simple, and reference can be made to the description of the method section when needed.

The above description of the disclosed embodiments enables those skilled in the art to practice or use the present invention. Modifications to these embodiments will be apparent to those skilled in the art, and the general principles defined herein can be implemented in other embodiments without departing from the essence or scope of the present invention. Accordingly, the present invention will not be limited to the embodiments described herein, but will cover the widest scope consistent with the principles and novel features disclosed herein.

What is claimed is:

1. An operation control system for a gas-steam combined cycle generator unit, comprising
a real-time operation data acquisition module, configured to collect operation parameter data and power generation data of a power plant unit,
an operation status evaluation index mining module, configured to mine and analyze the operation parameter data of the power plant unit to get key parameters,
an operation status evaluation index extraction module, configured to obtain characteristic variables,
an operation characteristic parameter prediction module, configured to predict the said characteristic variables and obtain a predicted value and a corresponding change trend, and
an operation intelligent control module, configured to realize intelligent control of parameters.

2. The operation control system according to claim 1, further comprising an operation status evaluation index selection module, configured to screen the said key parameters, obtain operation parameters positively correlated with the said power generation data, and send the said operation parameters to the said operation status evaluation index extraction module for processing.

3. The operation control system according to claim 1, further comprising an operation status evaluation index analysis module, configured to analyze the said key parameters and obtain operating condition stability judgment parameters.

4. The operation control system according to claim 3, further comprising a steady operating condition establishment module, configured to label the said operating condition stability judgment parameters, and establish a stable operating condition database.

5. The operation control system according to claim 1, further comprising a data preprocessing module, configured to preprocess the said operation parameter data of the power plant unit.

6. A method for optimizing and controlling operation parameters of a power plant unit, comprising
step 1: obtaining operation parameter data and power generation data of a power plant unit with a real-time operation data acquisition module, and preprocessing the operation parameter data and the power generation data;
step 2: mining the said operation parameter data obtained in step 1 with operation status evaluation index mining module to get key parameters;
step 3: processing the said key parameters with the said operation status evaluation index extraction module and multiple modules to get corresponding characteristic variables;
step 4: predicting the said corresponding characteristic variables with an operation characteristic parameter prediction module to get a predicted value and a corresponding change trend;
step 5: analyzing the said key parameters with a steady operating condition establishment module to get operating condition stability judgment parameters, and labeling the said operating condition stability judgment parameters to establish a stable operating condition database;
step 6: in combination with the said stable operating condition database, the said predicted value and the corresponding change trend, carrying out comparative control with an operation intelligent control module, to realize intelligent control.

7. The method according to claim 6, wherein the said step 3 further comprises
step 31: screening the said key parameters with an operation status evaluation index selection module to get operation parameters positively correlated with the said power generation data;
step 32: analyzing the said operation parameters with an operation status evaluation index analysis module to get the operating condition stability judgment parameters.

8. The method according to claim 6, wherein in the said step 2, the operation parameter data is mined by an improved association rule mining method.

9. The method according to claim 7, wherein in the said step 32, a clustering method is used to have a correlation analysis of the operation parameters to get the operating condition stability judgment parameters.

10. The operation control system according to claim 2, further comprising a data preprocessing module, configured to preprocess the said operation parameter data of the power plant unit.

11. The operation control system according to claim 3, further comprising a data preprocessing module, configured to preprocess the said operation parameter data of the power plant unit.

12. The operation control system according to claim 4, further comprising a data preprocessing module, configured to preprocess the said operation parameter data of the power plant unit.
